(19) United States
(12) Patent Application Publication
(10) Pub. No.: US 2003/0135294 A1
(43) Pub. Date: Jul. 17, 2003

(54) Sound generation IC chip set

(76) Inventor: Peter Ar-Fu Lam, Torrance, CA (US)

Correspondence Address: Peter Ar-Fu Lam, 20104 Wayne Ave., Torrance, CA, 90503, US

(21) Appl. No.: 10/371,283

(22) Filed: Feb. 21, 2003

Related U.S. Application Data
(63) Continuation-in-part of application No. 10/227,708, filed on Aug. 26, 2002.
(63) Continuation-in-part of application No. 09/896,434, filed on Jun. 29, 2001.
(63) Continuation-in-part of application No. 09/419,752, filed on Oct. 16, 1999.
(63) Continuation-in-part of application No. 09/169,462, filed on Oct. 9, 1998, now abandoned.

(51) Int. Cl. G06F 17/00

(52) U.S. Cl. 700/94

(57) ABSTRACT

The invention discloses a microcontroller comprising a first and a second processor ICs. The first processor IC is configured to store data representing sound signals and to perform decompression process for retrieving said sound signals. The second processor IC is configured to provide I/O pins for interfacing with external application circuits. An integrated programming technology is developed to program both processor ICs at the same time.

### RELATED APPLICATIONS

This is a continuation in part of pending U.S. patent application Ser. No. 10/227,708 filed Aug. 26, 2002; Ser. No. 09/896,434 filed Jun. 29, 2001 pending issue and Ser. No. 09/419,752 filed Oct. 16, 1999, which is a FWC and continuation in part application of Ser. No. 09/169,462 filed Oct. 9, 1998, and was later abandoned.

### FIELD OF THE INVENTION

The present invention relates to integrated circuits chip set of microcontroller, particularly a microcontroller configured for generating voice and sound signals.

### BACKGROUND OF THE INVENTION

Traditional microcontroller integrated circuits (ICs) are single chip IC comprises of input/output (I/O) ports, memories and specific functional circuits suitable to be integrated into the microcontroller chip body. External application circuits such as resistor identification circuits and motor driving circuits making use of discrete digital and analog components are provided outside the IC body. Additional ICs of special functions such as operational amplifiers and comparators are also provided outside the body of most digital ICs. On the user side, there is always a push to integrate more functional blocks into the IC body in order to reduce product cost. Since application circuit requirements vary, IC designers and manufacturers are required to provide different families of microcontrollers ICs each having a different functional performance, or interfacing specifications to meet the different application needs of the users.

With the increasing complexity of application circuits and higher density IC fabrication technology, there are increasing difficulties to decide which features are to be provided inside an IC body so as to minimize IC design investment, reduce product cost while satisfying the needs of customers. It is the objective of this invention to extend the VSFB (variable specification functional blocks) research for minimizing the difficulties faced by the industry of microcontroller chips suppliers, particularly the microcontrollers designed for generating sounds and voices used in toy products. It is also the objective of this invention to offer a generic power management processor IC specially designed for driving speakers, offering I/O pin for interfacing with external application circuit of a product design and providing regulated voltage to power other lower voltage supporting processor ICs to form a chip set.

### SUMMARY OF THE INVENTION

The present invention is first directed to programmable sound/voice generating ICs. These ICs are commonly used in consumer electronics products, particularly for toys and gifts. Typical voice generating microcontroller IC comprises memory means for storing the sound or voice messages; I/O ports for interfacing with external application circuits and D/A (digital to analog) converters to convert digital data into analog signals suitable for feeding an audio amplifier or directly driving a speaker. Small amount of memory capacity is also allocated to store the application program. Memory means of microcontrollers are represented by ROM (Read Only Memory), RAM (Random Access Memory), Flash Memory or other different kinds of logic storage devices. ROM is the lowest cost memory available but they are not re-recordable. Most consumer and toy products use ROM to store preprogrammed sound or voice messages. The duration of the voice message stored depends on the size of the storage memory and the compression ratio of the voice encoding/decoding method, which also affects the voice quality.

Before digital data representing voice signals are masked for storage in the ROM area of a voice generating microcontroller IC, analog voice signals are sampled and converted into digital format by analog to digital (A/D) converters in a development to provide PCM (pulse code modulation) data. The digitized audio data may be further compressed to provide higher memory efficiency. There are different kinds of encoding/decoding methods to compress sound/voice data. The methods most commonly used are ADPCM and CELP. CELP is a vocal simulation method that requires more complex circuitry and computing resources than ADPCM decoding, but it offers higher compression ratio for reasonable voice quality. With the popularity of the high processing power DSP (digital signal processing) chip, better vocal simulation methods are now available to provide good sound quality at a higher compression ratio. The draw back for vocal simulation methods is that large area of the IC space is provided for the voice engine portion. Significant ROM area is also required to store the decoding algorithm. These limitations make vocal simulation methods and DSP methods less suitable for short duration voice generating ICs. Voice engine is defined as the software/hardware components required to process the ROM data for generating simulated voice and sound signals. In the case of vocal synthesizer IC chips, software and the ROM space it occupied form an important part of the voice engine.

Existing commercially available voice generation chips are provided with different families of IC chips. Each of the IC families is provided with different characteristics. Some voice IC families are designed for low computing power applications while the high end IC families are single chips that provide sounds as well as LCD driving capabilities for electronics such as hand held games. Each member of an IC family comes with different memory sizes to optimize the cost of the chip for use in different applications that require different voice durations. As an example, each IC body of a voice generation IC product line includes a standard decoding circuit, DAC (digital to analog conversion circuit) and a standard speaker driving circuit. Choices of different ROM sizes in the IC family are available to provide 3 seconds, 6 seconds, 12 seconds and up to multiple minutes of voice messages. Each IC members of the product line, although using substantially the same core circuits, requires a separated set of mask to fabricate the IC, due to the different ROM sizes provided. Each member IC of the product line also requires engineering time and overhead to reroute the IC layout design during development stage. Accordingly, the cost to develop the IC product line increases with the number of IC members designated in the family to meet the marketing requirements. Assuming a voice IC product family has ten different members, each providing a different voice duration; by introducing an additional function such as an integrated resistor identity detection circuit, the product line is required to be expanded to 20 different IC members, ten with resistor identification capability and ten without. The number of I/O pins is another important factor dictating the number of family members required in the product line. The number of I/O pads also forms a significant portion of the cost of an IC especially when the dice size of the IC is small. Assuming there are ten different ROM sizes variations and five different I/O pads variations, the total possible IC chip combinations is 5×10=50. When the optional resistor detection feature is added, the number of possible combinations is extended to 100 that is well beyond the reasonable number of IC members to be included in an IC product line. In addition to voice data, many voice IC families also service other memory intensive applications. Typical examples in the consumer electronics and toys fields are the LCD games, which is driven by a single voice plus LCD IC chip. The nature of VSFB (Variable Specification Functional Blocks) and I/O pads characteristics also contributes to IC product planning considerations. VSFB are defined as blocks of special optional functional IC circuits required to supplement the functions of a standard microcontroller. Infra red control functions, and RFID (radio frequency identification) are examples of special functions to be added to enrich the servicing scope of a microcontroller.

Input/output pads themselves may have different design characteristics to meet different user requirements. Output pins required to drive LED directly should provide higher current capability and therefore bigger IC dice size than the output pins for regular logic interface. Output pins designed for driving LCD is required to provide multiple levels driving waveforms. Output circuits designed to drive a speaker also comes with different circuit designs. The most common speaker driving designs are analog voltage drive and PWM drive. Analog voltage drive delivers an analog signal across the speaker. PWM signal in fact is also an analog signal that controls the analog power by varying the pulse width of the signal. Driving speaker directly with an analog voltage signal is too expensive for most IC designs. Accordingly a transistor is added to amplify the current for driving the speaker. PWM (pulse width modulation) is the most popular method for an IC to drive speaker directly. It takes less average current because the speaker is driven in both directions. However, due to excessive voltage drop at the output circuit of the IC, PWM is less desirable for low voltage operations. This is particularly important as most toy products are designed to work with two to three batteries. Batteries voltage drops when power is drained. Application circuit designed to work with two batteries should work between 2V to 3.3V. The working voltage of three batteries operation is between 3V to 4.8V. Adding all the special functional features and I/O variations makes the IC product planning issues over complicated.

In order to keep the product price low, shorter duration sound generation chips are provided with fewer I/O pins. The IC suppliers provide more I/O pins for longer duration voice controller chips. On the application side, it is not always true that products requiring long sound or voice durations will need high number of I/O pins. In fact, many products that need long voice duration require only simple logic and very few I/O pins. In contrast, many toy products that need lot of computing power and many I/O pins may require merely several seconds of sound effects. It is becoming more complicated to consumer microcontroller IC product planners to provide the optimal IC product planning when other feature related variable IC specifications, such as infrared remote control, RFID (radio frequency identification) functions are considered. It is the objective of this invention to simplify the complexity of IC product planning by using the variable specification functional blocks technology disclosed in the parent patent application. It is also a further objective of this invention to provide an improved product planning for processor ICs, particularly for sound or voice generating microcontrollers to satisfy variable I/O and memory demands in the field.

Attention is now directed to the different processes of fabricating microcontroller chips, particularly the high memory content voice IC chips. Most short duration voice generating microcontrollers as of the patent application date make use of fabrication process over one micron on 6 inches wafer. Long duration, high ROM size voice generating ICs are fabricated by higher density sub-micron technology on 8 inches to 12 inches wafers. Larger wafer size not only provides more chip space, higher fabrication density (more transistors per unit area), the thicker wafer also provides more layers of logic circuit. However, the higher the density of the fabrication technology, the lower is the breakdown voltage of the logic circuit, which results in lower operating or working voltage of the circuit. High circuit density fabrication also enables the IC to run at a higher clock rate. High density fabrication process is particularly suitable for powerful processing microcontrollers such as the DSP chips, which requires high speed clock rate, high capacity logic, high volume ROM space and high complexity circuits such as hardware multiplier and other supporting memory and circuits built in. On the other hand, the cost per bonding pad is comparatively higher for the high density process because of the higher per unit IC area cost and fixed pad size required. Problems faced by IC product planners are high bonding pad cost for low end chips, higher cost for power driving circuits with high density fabrication process and too many IC bodies per family. A challenge faced by the application engineers is the low working voltage required by the high density fabrication process, which failed to deliver adequate speaker volume. Users also feel the difficulty to find the optimal microcontroller chips when too many IC bodies are available from different suppliers in the market. In addition, programming is also an issue in the field. The microcontrollers offered by different companies usually require different programming languages and development tools. It is another objective of the subject invention to simplify the programming workload of the application programmers designers and programmers.

In a first application example of this invention, a microcontroller in the form of chip set comprises at least two processor ICs. A processor IC is defined as a programmable integrated circuit that comprises an ALU (arithmetic logic unit) for processing data and providing logical decisions, memory for storing program and data, and I/O pins for communicating with the outside circuit. The ICs of a chip set are special ICs designed to work together for fulfilling a design goal. In a preferred embodiment of the invention, two processor ICs are connected together such that the first processor IC is configured to provide abundant amount of memory for storing compressed voice/sound data. The second processor IC is configured to provide adequate I/O pins for interfacing with external application circuit. A circuit designer completes an electronics product design by providing suitable external application circuits to work with the two processor ICs connected together.

The structure or logic flow program interacting with the I/O pins is mainly provided by the second processor IC. The decoding or decompressing circuit can be provided by either the first or second processor IC. Complex decompression circuitry is recommended to located at the second processor IC, so that significant cost saving can be achieved when the second IC is provided by a high density fabrication process. Product line of the first processor IC varies according to the different memory size required for storing different durations of sound/voice messages. Product family of the second processor IC focuses on the variation of I/O pins and other important VSFB circuits. Application engineers select an IC member from each of the two families according to the product requirements. It is an objective of the invented chip set microcontroller to minimize high power circuit and bonding pads on the high density first processor IC. Accordingly the D/A converter and the speaker driving interface is recommended to locate at the second processor IC which makes use of cheaper lower density fabrication process. This method offers another advantage for the applications engineers when the first processor IC is fabricated with process for the IC to work up to 3.3V, which is inadequate to reasonably driving a speaker directly.

When an input pin of the second processor IC receives a trigger signal or when the program logic flow demands a sound, an identifying signal is sent to the first processor IC telling which sound is requested. The first processor IC fetches the stored sound data from the memory and feed the processed, semi-processed or unprocessed data to the first processor IC. The first processor IC provides the high power circuitry for driving the output audio signal to the external speaker driving circuit, or to the speaker directly. The data stored in the memory block of the first processor IC is processed, decompressed or decoded to provide the final audio signal ready to drive a speaker. A semi-processed data is any data positioned in between this decompression or decode process before a signal is ready for an external sound transducer. It should be noted that the decompression or decoding processes could be performed by the first processor IC, by the second processor IC, or by the join effort of both processor ICs. When a DSP chip is used as the first processor IC for the decompression process, the majority decompression process should be provided by the DSP chip. Although both processor ICs are provided with I/O pins, the I/O pin count of the first processor should be minimized according to the objective of the invention. The majority number of I/O pins for interfacing with external application circuit should come from the pads dominating second processor IC. Similarly, although both processors are provided with memories, the majority memory population, such as the big memory blocks required for storing audio data, should locate inside the first processor IC. The minimum number of communication pads of the first processor IC is two, one for receiving identification signal in serial format and one for sending sound related data or signals to the second processor IC. The identification signal in this case point out the location where the data are to be fetched from the IC memory for processing. The bonding pad representing the I/O terminals of a processor in dice form is commonly known as a “pad”. The I/O terminal of a processor in packaged form is commonly referred as a “pin”. Pads, pins or terminals in this application carry the same meaning as the input/output terminal of an integrated circuit to be connected with an external circuitry.

Applicant's allowed parent U.S. patent Ser. No. 09/896,434 application disclosed the concept for a first processor IC to provide power to a second processor IC. In a preferred embodiment, the first processor IC is fabricated by a low voltage process, say 3.3V, and the second processor IC is processed by a lower density, higher voltage and lower cost process, say 5V. It is also desirable for the second processor IC to have a special output pin for providing the lower voltage required to power the first processor IC. A circuit inside the second processor IC steps down or reduces the higher voltage power received by the second processor IC to a lower voltage suitable for powering the first processor IC. Since battery voltage fluctuates according to current draw, the lower voltage provided by the second processor is preferred to be regulated at a fixed lower voltage. Accordingly a voltage regulator for powering the first processor IC is provided inside the second processor IC. As all the high power circuits are removed to the second processor IC, very low current will be drawn by the first processor IC. Therefore the voltage step down circuit and/or regulator circuit of the second processor IC does not require high power layout designs. In addition, since the two processor ICs are bonded adjacent to each other on a printed circuit board to form a COB (chip on board) microcontroller assembly, the current driving capability of the interfacing I/O circuit between the two processor ICs can be much smaller than the layout design of regular communication ports.

When the two processor ICs are working together at different supply voltage levels, the communication I/O pins of the second processor IC connected with the first processor IC should be modified such that the threshold level and maximum voltage matches the lower working voltage of the first processor IC. Typical step down voltage arrangement using resistor voltage divider circuit are well know to an ordinary person skillful in the art and therefore not described in further detail herein. Since the role of the first processor IC is for high density memory storage and high speed computation, the first processor IC is not much involved in the majority program flow of the application program. Accordingly the first processor IC requires a direction from the second processor IC to enter into a lower current standby or sleep mode. This can be achieved by reserving a sleep or standby code in the commands sent from the second processor IC to the first processor. As a summary, the minimal number of I/O pins required by the first processor IC is four, that includes a power pin, a ground pin, a pin to receive identity signal from the second processor IC and a pin to transmit audio signal or data to the second processor IC for driving a transducer, such as a speaker. In most microcontroller designs, one to two additional pins are required for activating the clock oscillator. It should be noted that the terms microcontroller defined herein is not limited to a single processor IC. It may represent multiple processors combined in the form of a COB to provide similar function of a larger, more powerful microprocessor.

It is another objective of the subject invention to provide a generic power management processor working at a higher voltage to interface and supply power to for other lower voltage higher density processors. This generic power management processor is configured to offer the following features:

(1) Provide step down and/or regulated voltage for other processors working at a lower voltage.

(2) Provide step down voltage interfacing circuit to communicate with the I/O pins of the lower voltage processors.

(3) Provide full voltage I/O lines to interface with external application circuit.

(4) Provide audio signals or speaker driving circuit in the case of a voice chip based microcontroller system.

When the power management processor is grouped with selected external lower voltage processors to form a microcontroller, the majority I/O lines is recommended to be provided by this power management processor. Similarly, the resident program controlling the interface between the I/O lines of the microcontroller and the external application circuit is also preferred to be provided by this power management processor. However, the computing intensive program should be provided by a high speed DSP processor connected to it. The memory intensive audio/visual data storage and high speed processing portions are more economical to be provided by the high ROM content supporting processor connected to the assembly. In order for this generic power management processor to work with different families of supporting processors, it is highly preferable to have a standardized communication protocol that works with every member of the supporting family of processors. The standardized communication protocol will vary according to the nature of the supporting IC chips. In the case of voice generation chips, a standardized half or full duplex serial communication channel with handshake signals should be adequate. For hand held LCD games, the protocol should be defined according to the nature of the data to be sent, the speed of data to be transferred and the specific hard communication configurations required. Typical enhancements of hardware communication interface include but not limited to parallel ports, latch control and modulated signals. Another preferred embodiment of power management processor is to have input pin configured to receive lower voltage signal form a supporting processor that works at a lower voltage. The power management processor in turn transforms the interfacing characteristics of this signal and send it to an output pin for interfacing with an external application circuit. An example of the interfacing characteristic transformed is a corresponding signal of higher voltage. Another example of the interfacing characteristic transformed is higher current drive of the output pin.

Attention is now directed to the technique of IP (integrated programming) developed through the research of the subject invention. Integrated Programming is defined as the method to provide a compiler suitable for programming more than one processors, or in this case the first and second processor ICs, all in one program, and at the same time. A compiler is a software that translates a program written by a programmer into one or more programs executable by a processor. In the integrated programming environment, the compiler treats all ICs on the COB as one single entity, or a single larger, more complex IC. The compiler is arranged to automatically provide the following hidden functions without the attention of the programmer:

1. Establish communication protocol between the processor chip set according to the connection specified and the type of chip selected; and

2. Handle control timing between the communication signals.

Another model to visualize and understand Integrated Programming is for the compiler to treat the whole COB assembly as one single ASIC chip, although actually they are different processors located on the same COB assembly. In addition to carrying out the above hidden communication and timing functions specified, the compiler distributes the program instructions to the driving programs of individual processor ICs and centrally coordinate the interactive activities between these processor ICs. The technique is applicable to many programming languages such as Assembly Language and the higher level Easy Format® language as disclosed by the applicant in U.S. Pat. No. 5,867,818 and pending U.S. patent application Ser. No. 09/419,752. Easy Format® program is defined as a programming method that provides multiple tables to define the program flow; wherein a first table defines the states; each state defines the I/O activities that specify what happens when an input pin goes high or when it goes low, and the logic level or signal to be sent from an output pin when a state is activated. During programming, the programmer specifies the different qualifying conditions of input pins. When a qualified input trigger is received, a second table defines the path, or sequence of activities to be carried out by the microcontroller, according to the wish of the programmer. In the application of IP, an Easy Format program written by a programmer treats the two processor ICs as a single microcontroller. After compiling, two executable ROM codes are provided for the ROM area of each processor ICs. As a result, IP programming technique transforms a single application program into two driving programs, one for each of the processor ICs in the IC chip set. This transformation process is transparent to users as the two processor ICs combined are considered to be the equivalent of a single bigger, more powerful microcontroller IC.

The novel features of the invention are set forth with particularly in the appended claims. The invention will be best understood from the following description when read in conjunction with the accompanying drawings.

### BRIEF DESCRIPTION OF DRAWINGS

FIG. 1 is a prior art single chip voice/sound generating IC.

FIG. 2 illustrates the arrangement of using a resistor detection chip as a special function IC to interface with a standard voice generating chip;

FIG. 3 introduces the arrangement of a VSFB circuit design that interfaces a VSFB resistor detection IC with a VSFB voice generating IC;

FIG. 4 is a COB assembly having four VSFB dices bonded on the same PCB, each linked to the central processor IC by a serial link;

FIG. 5 is the circuit diagram representing three VSFB chips assembled to form a COB;

FIG. 6 is a voice/sound generating chip set of a preferred embodiment;

FIG. 7 is a COB assembly having two VSFB processor ICs to form a microcontroller;

FIG. 8 illustrates interface between the two processor ICs combined to form a complete microcontroller;

FIG. 9 illustrates the COB arrangement of a preferred embodiment; and

FIG. 10 demonstrates an example of Easy Format® program suitable to program the sound generating microcontroller chip set.

### DESCRIPTION OF THE PREFERRED EMBODIMENT

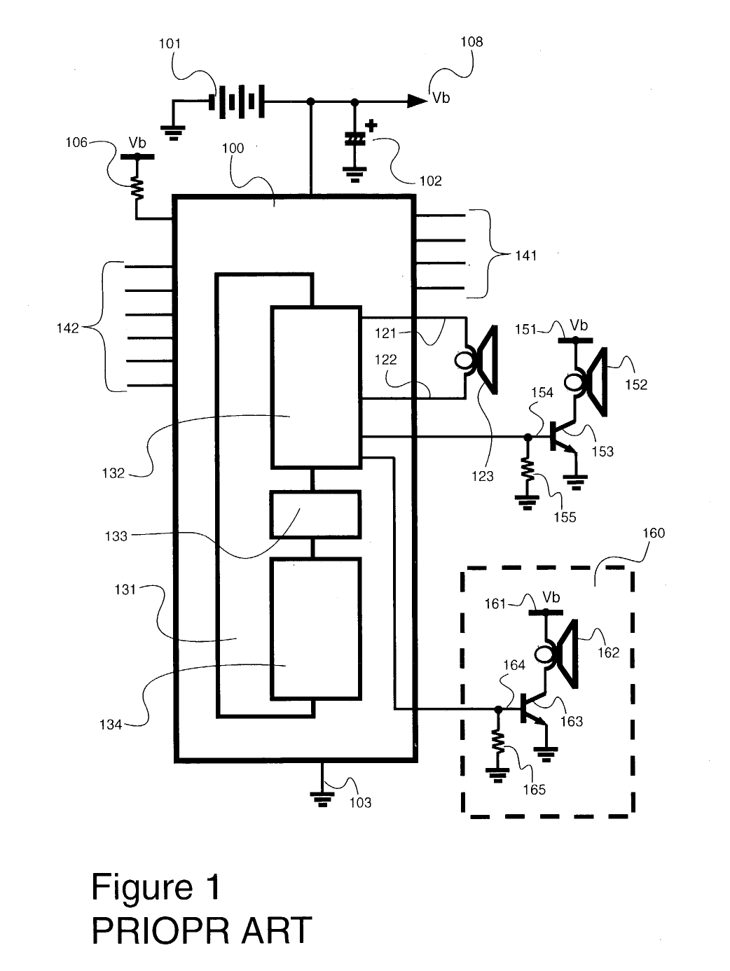

FIG. 1 illustrates a prior art single chip voice processor. This type of single chip microcontroller is very popular in consumer electronics and toy applications. The battery 101 offers power to the IC body 100 as well as the external application circuit through the path 108. The oscillator of the IC is provided by the pull high resistor 106. Inside the IC is a core processor, or ALU 131, which manages the I/O, memory and activities of other supporting circuits including the DAC (digital to analog converter) 132. Input terminals 142 and output terminals 141 enable the IC to communicate with the external application circuit. In many IC designs, I/O terminals are programmable and can be shared by input, output or special functional circuits, such as modulated infrared transmitter. ALU 131 may be equipped with other important supporting circuits such as stack pointer, registers, or buffer RAMs. These structures are well known to an artisan skill in the art and therefore detail description of a generic microprocessor is not repeated here.

Attention is now directed to the sound generating circuit. In order to service as a sound/voice synthesizer chip, memory blocks 134 is provided to store digital data representing audio signals. These data represents the encoded or compressed information of an analog audio signal. These audio data can be in pure PCM format, compressed code of ADPCM, CELP or in the format specified by any other compression algorithm. A relatively small amount of the memory is also allocated to store the application program. The storage memory of commercial voice chips is usually in ROM form. It means the execution program and audio data are masked into the IC chip. The functional block 133 represents the special decoding or decompression hardware required by a sound/voice chip to retrieve audio data from the memory and convert the data back into the audio signal. The decoded data is fed to the DAC 132 for reconstructing the analog audio signal. The audio signal in PWM form may be used to directly drive a sound transducer, represented by the speaker 123 through the terminals 121 and 122. Alternately, audio signal can be reconstructed by the DAC 132 to provide an analog voltage signal for driving the current amplifying transistor 153, which drives the speaker 152. The resistor 155 controls the biasing of the transistor 153 to minimize analog signal distortion. In some audio IC design, multiple channels audio output terminals are provided. For example, a powerful voice chip is capable of providing multiple output channels to drive the transistors 153 and 163 for producing stereo effect. Multiple audio signals can also be mixed before they are sent to drive a speaker.

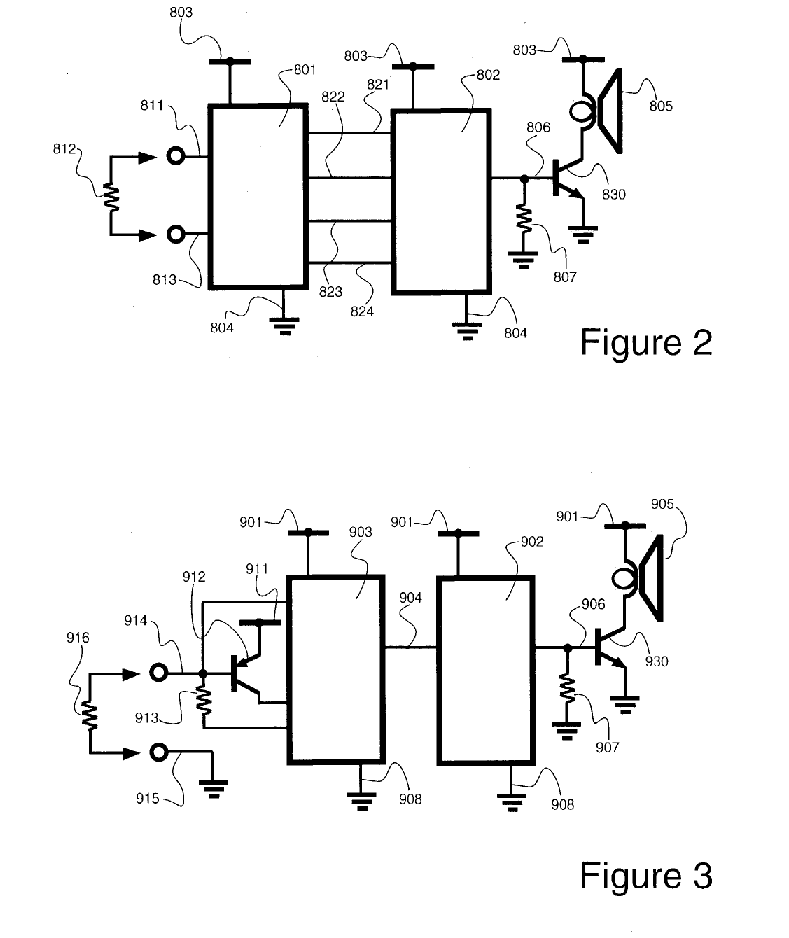

FIG. 2 and FIG. 3 illustrates VSFB (variable specifications functional blocks) applications. FIG. 2 demonstrates a special function, resistor detection IC 801 to interface with a voice generating chip 802. The four interfacing lines 821-824 provide the identity of 16−1=15 resistor values; each directs the voice generating processor 802 to deliver a different sound when a specific resistor value is detected. To make the connection simpler to work with a higher number of resistors, the two chips are connected by a serial link 904 as shown in FIG. 3 and the resistor detecting input is buffered by the transistor 912. From here a VSFB example is illustrated that makes use of a standardized serial link to interface with different functional specific ICs. All these IC are combined on a COB (chip on board) assembly. The whole COB assembly in fact simulates a complete function specific ASIC chip or a more complex microcontroller. The standardized serial links can be cascaded or daisy chain connected to minimize the number of serial ports required by the central controller. Although each VSFB IC requires a program to perform it's intended function, an IP (Integrated Programming) method is developed such that a single program is required to program the central controller and all the different VSFB chips at the same time. Of course IP programming requires the programmer to specify what type of VSFB ICs are combined together, and how they are connected together. Since all connections and interface characteristics are predefined, IP programming will provide executable codes to control all related VSFB ICs with one program, treating all VSFB ICs assembled together as a single microcontroller IC.

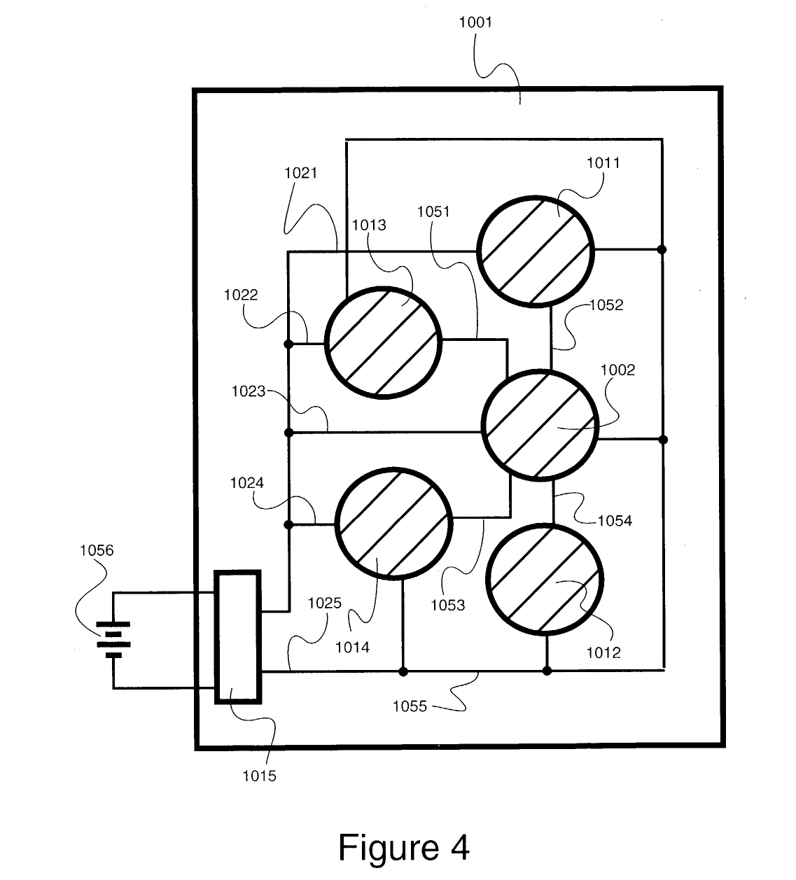

FIG. 4 illustrates the physical top view of a COB that makes use of the VSFB technology. The core processor 1002, and the VSFB ICs 1011 to 1014 are “die bonded” onto the printed circuit board 1001 to form a COB (chip on board) assembly. Each of the VSFB ICs 1011 to 1014 is connected to the core processor 1002 via the standardized serial links 1051 to 1054. In this illustration the VSFB ICs do not draw power from the core processor. Each of them has a power line 1021 to 1025 connected to the power socket 1015 that obtained the power supply from the batteries 1056.

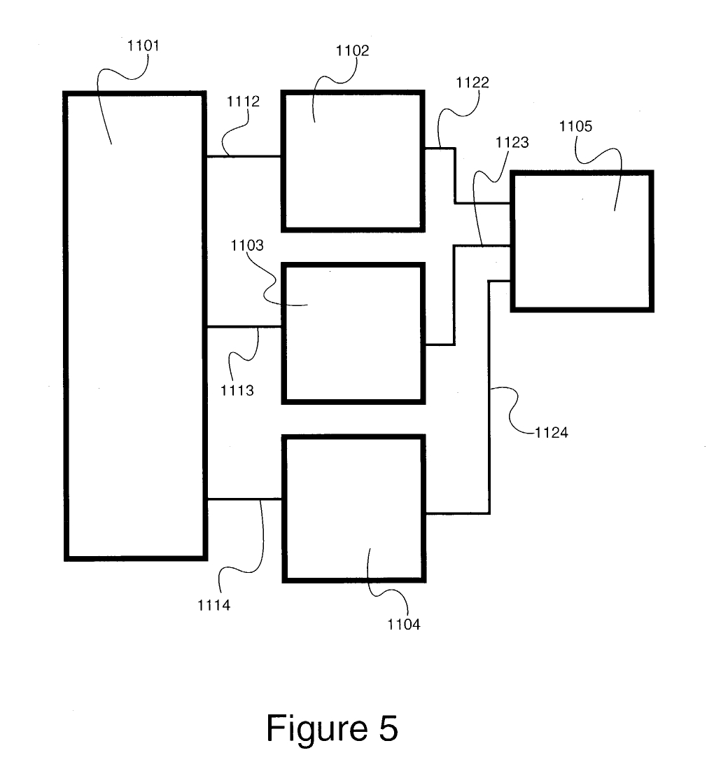

Since the IC dies 1002, 1011 to 1014 are closely located together as shown in FIG. 4, the current handling capability and the noise immunity capability is compromised to reduce the cost of the ICs and also to minimize EMI interference. FIG. 5 illustrates the circuit diagram that has three VSFB ICs 1102 to 1104 connected to the core processor 1101, each via the standardized serial communication lines 1112 to 1114. The power lines of the VSFB ICs are connected separately to a power source 1105. An Integrated Programming compiler handles the COB 1001 of FIG. 4 as a single microcontroller. The codes generated are then embedded into the memory of the different VSFB chips.

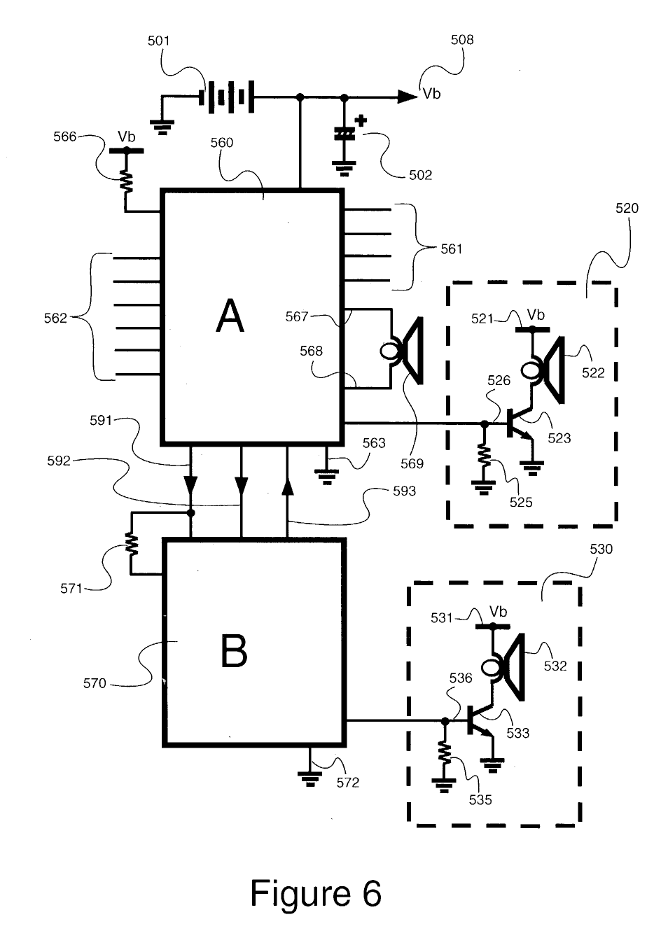

FIG. 6 illustrates a preferred embodiment of the subject invention, which provide a special VSFB arrangement of two processors to form a single sound generating microcontroller. Processor IC A, 560 and B, 570 are connected by the lines 591 to 593. Processor B is configured to provide all the high density circuits, such as the processor of a DSP chip, or high volume of ROM data. Processor A is configured to accommodate most of the high power circuits and large size circuits such as I/O pads. I/O bonding pads requires a certain minimum IC chip area no matter how high the density of the fabrication process is used. Typical high power circuit of a voice/sound generating chip are the high current output pins and also the speaker driving pins 567 and 568. It is the preference of this chip set design to minimize the bonding pads of the processor B. Accordingly the majority I/O pins of the chip set, ICs A and B combined are to be positioned in IC A.

In order to provide a cost effective arrangement, IC B is fabricated with a higher density process than IC A. Higher density fabrication process provides higher resolution integration, bigger wafer size, more layers of logic per wafer, higher speed, lower operation power and lower working voltage. Accordingly, the logic intensive circuits such as the core of a DSP chip and the high volume memory areas are allocated to IC B. The reasonable minimum communication pins connected between ICs A and B are two, represented by the communications lines 592 and 593.

Since the majority I/O pins of the microcontroller represented by the chip set shown in FIG. 6 locates at IC A, the execution program for the microcontroller to work with the external application circuit is preferred to locate at IC A as well. Any memory intensive data storage, high complexity circuits or high speed processing will be provided by IC B. When an input pin 562 of IC A receives a trigger signal demanding a voice response, the identifier of the voice, or location of the memory address where the voice is stored, is sent to IC B by the communication line 592. After fetching the audio data, IC B starts to decode or decompress the ROM data and converted the data into analog signals suitable for driving a speaker. It should be noted that the decoding process may be carried out in IC A, or in IC B, or both combined depends on the nature of the decoding/decompression requirements. For computation intensive decoding process that requires a DSP chip, the majority decoding process should be provided by IC B, which represents the location of the DSP core. Raw ROM data, semi-processed data or fully decoded signal is then sent to IC A via the communication line 593 for driving the speaker 569 or 522. Although full duplex serial communication lines are provided between ICs A and B to reasonably minimize the number of pads required, the communication between the two processors ICs can be further simplified to half duplex format, or extended to parallel format according to the high data rate needs of the applications, without significantly changing the merits of the chip set arrangement.

Speaker drive from IC B is normally not required as all I/O interface with external application circuits as well as the speaker driving functions are offered by IC A. In a very special product application, long duration voices are playback in response to pushing a single trigger pin, it is possible to arrange IC B alone to work for this application. In this situation, the benefits of IC A is not obvious, therefore an optional lower current analog DAC represented by pin 536 is provided. When the trigger signal is received by the line 592, processor IC B decodes the audio data stored inside it's memory and provides the analog current to the transistor 533 for driving the speaker 532.

For analog signal provided in PWM format, it is possible for a processor IC to drive a speaker directly. This is illustrated by the pins 567 and 568 of IC A. However, since the driving circuit of CMOS process requires some significant voltage drops, direct PWM driving is not suitable for low battery application such as the power supply of two AA batteries. Accordingly there is a desire for an electronics product to use at least three batteries, for a voltage supply between 3V to 4.5 V, when direct speaker drive is required. In the situation if a very high density sub-micron fabrication process is used to provide IC B, the operation voltage of IC B will be below 3.3V. Then the two ICs are operated at different logic voltages. Accordingly a voltage step down circuit is arranged inside IC A to provide a suitable working voltage to power IC B through the power line 591. Resistor 571 is the oscillation resistor of IC B connected to this power line. Since IC B is normally not required to deliver output current, it is possible for IC A to provide a very low power and low drop out voltage regulator for powering IC B through the line 591. This voltage regulator regulates and limits the supplying voltage below 3V for IC B. In addition a voltage conversion interface circuit is required at the side of IC A to provide lower voltage signal to IC B through line 592. The input pin of IC A to receive signal from line 593 is also tuned to have a trigger threshold approximately equal to half of the voltage supplied to IC B through the line 591 for optimal performance.

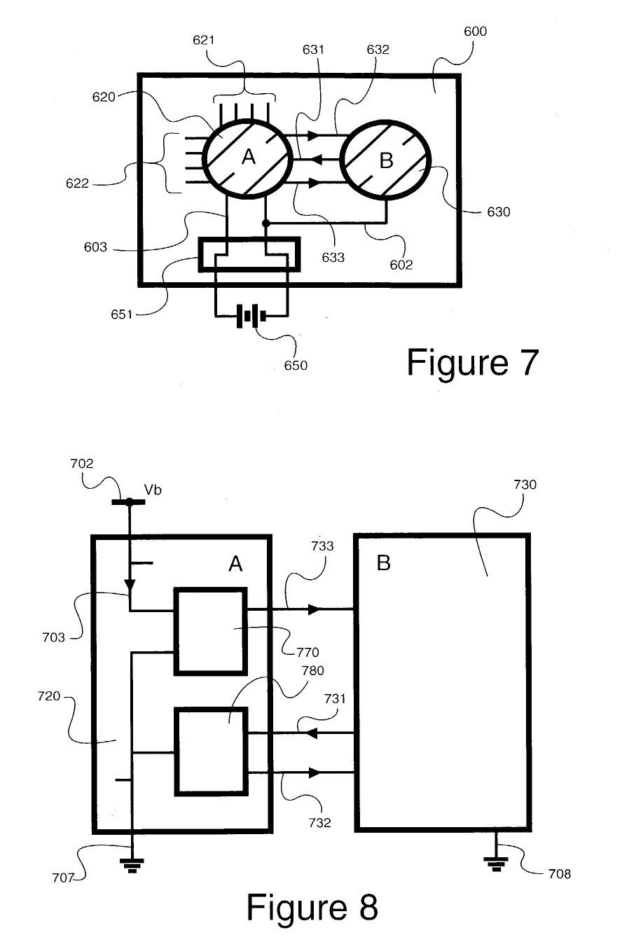

FIG. 7 illustrates the microcontroller formed by the chip set of FIG. 6, bonded on a printed circuit board 600 to form a COB (chip on board) microcontroller assembly. Processor IC A receives power from the battery 650 through the connector 651 and the path 603. The negative terminal of the battery 650 is connected to both processor ICs. Line 633 is the step down regulated voltage supplied by the processor IC A for powering IC B. Terminals 621 and 622 of IC A represent input and output pins for the microcontroller assembly to interface with external application circuit. When IC A receives a trigger, an identity signal is sent from IC A to IC B, according to the instruction of a program embedded inside IC A. In response to the identification signal received, IC B fetches audio/visual data from it's memory, processes the data and feeds the audio/visual information to IC A through the line 631. IC A is then responsible for the higher current job to provide the final processed signal to an outside transducer. In the case of an audio signal, a PWM audio signal is connected directly to a speaker or an analog voltage signal is sent to a current amplifying transistor for driving the external speaker. Depends on the structure of the chip set, processor IC A may be required to support processing the data received from IC B for converting into the analog signal required to drive the speaker.

A generic power management processor IC A, 720 configured to work with an external processor 730 is illustrated in FIG. 8. Inside the power management processor A, a voltage regulator 770 reduces the voltage received from the power supply 720 to provide a regulated lower voltage for the IC B through the line 733. IC A also provides a step down interface circuit 780 to transmit and receive signals from the lower voltage processor B through the I/O lines 732 and 731 respectively. For IC A to work with different types of IC B, it is desirable for the power regular 770 and the voltage step down interface circuit 780 to be selectable for providing different lower working voltages to power different IC B selected. Selection of IC B working voltage can be achieved by program instructions or mask option of IC A. Not only IC B can be selected from a family of ICs providing different memory sizes and different interfacing requirements, IC A can also be selected from a family of ICs each equipped with different I/O pins characteristics and optional specific functions. Cross matching of the two IC families help to reduce product planning difficulties of IC suppliers. IC B of FIG. 8 is provided with four bonding pads. The ground terminal 708 forms the first pad. The second pad is to receive power from line 733. Line 732 enables IC B to receive identification signal and other commands from IC A. Line 731 is provided for IC B to send raw data, semi-processed data or fully processed data, final PWM or analog signal to IC A. Line 731 also serves as an output pin for IC B to communicate with the external application circuit when it works alone. Although IC B is shown with four connecting pads, lines 731 and 432 can be combines to provide a time-shared, two directional communication protocol. Alternately, more I/O lines can be added in between ICs A and B if much higher speed data transfer rate is required.

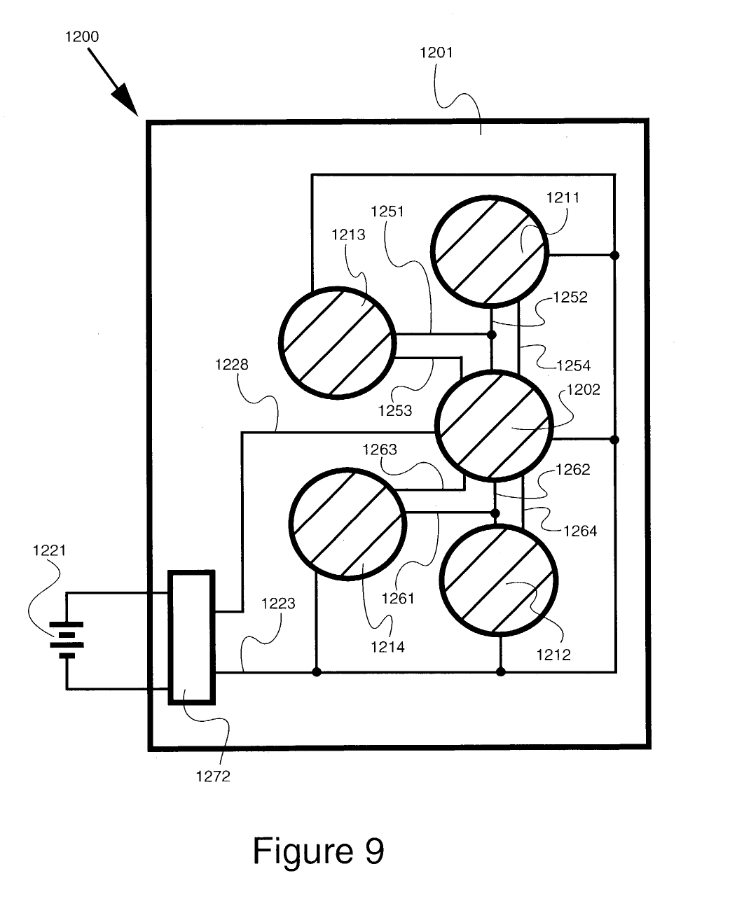

Attention is now directed to FIG. 9, which illustrates a microcontroller assembly 1200 that comprises an improved generic power management processor IC 1202. Processor IC 1202 is configured to interfaced with four lower voltage VSFB ICs selected. Processor IC 1202 receives power from the battery 1221 through the connector 1272 and the path 1228. A first lower regulated voltage is supplied to ICs 1211 and 1213 via the paths 1251 and 1252. Processor IC 1202 can also be programmed to provide a different second lower regulated voltage to ICs 1212 and 1214 via the path 1262. In additional to receiving regulated power supplies from IC 1202, ICs 1211 to 1214 communicate with processor IC 1202 through serial communication lines 1252, 1253, 1262 and 1263. It should be noted that processor IC 1202 also provides I/O pins (as shown in FIG. 7) for the microcontroller 1200 to interface with external application circuits. Not only the VSFB ICs 1211 to 1214 can be selected from a family of supporting ICs, processor IC 1202 can also be selected from a family of power management processors, each provides different I/O and optional specific functional characteristics. In summary, processor IC 1202 is the core element of the COB microcontroller 1200 supported with lower voltage VSFB ICs 1211 to 1214 to work with external components for building an electronics product. In order to support the special selectable structure of microcontroller 1200, an integral programming compiler is provide for a user to program all the programmable ICs on the COB assembly 1201. After specifying the selected ICs used on the COB assembly and how these ICs are connected with the core processor IC 1202, the compiler allows the user to program the COB assembly 1200 as a whole. The compiled program provides different executable codes, each required by a programmable member of the COB microcontroller assembly.

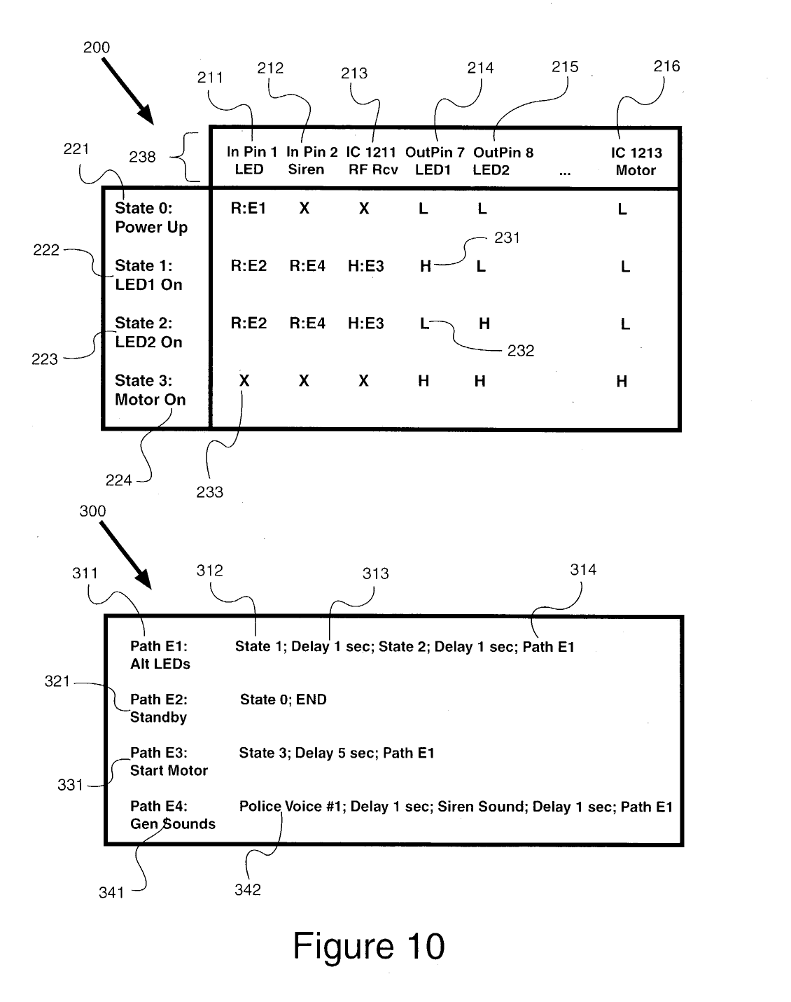

FIG. 10 illustrates an example of an integral programmed Easy Format program. This program refers to an application example of the COB microcontroller 1200 of FIG. 10. The application electronics product example is a toy police car having a button to turn the siren on. Another button is provided to instruct the two LEDs to blink alternately. The police car is also equipped with a motor, which can be turned on by a RF (radio frequency) remote control receiver. Attention is now directed to FIG. 9. The core processor IC 1202 is provided two input pins connected to the On/Off switch and the LED control switch. IC 1211 represents the RF remote control receiving IC connected with the core processor 1202. IC 1213 is a special function processor providing programmable current to control the speed of the motor. The desired high power motor current is delivered through an external transistor connected with the output pin of motor speed controller 1213. IC 1212 is a sound chip which operates at a lower voltage. The memory of processor IC 1212 is stored with encoded data representing all the sounds and voice messages of the police car toy product. Semi-processed sound data requested by the core processor 1202 is sent to core processor through a serial communication channel 1264. Core processor 1202 is further structured with a DAC, which drives a speaker for producing the siren and other sounds required by the product. IC 1214 is not used in this example application. Attention is now directed to the IP Easy Format program of this application example as illustrated in FIG. 10, which control the operation of the toy police car. An Easy Format program comprises of two or more interactive tables. The first table 200 represents the different states describing the I/O pins configurations of the police car under different situations. The path table 300 enlisted all the action sequences when an event is called. The first row of the table 200 is the title row 238 indicating the sequential header of the state table, which enlisted the I/O pins designation and also the triggering condition of the other VSFB ICs. The first column 211 of the table represents the triggering condition of input Pin 1 of processor IC 1202. This input line is connected to the switch that turns the alternately blinking LEDs on and off. The second column 212 represents input pin 2 of processor IC 1202, which is connected to a switch to turn the siren sound on. The third column is the interface pin connected with the RF receiver IC represented by the IC 1211 of FIG. 9, which instructs the core processor to turn the motor on, at a certain speed. Columns 4 and 5 represent output pins #7 and #8 of processor IC 1202, which are connected with LED1 and LED2. The last column represents the interface with IC 1213 of FIG. 9. There is always a Power Up initial State #0 in an Easy Format program, which defines the start up condition of the electronics product when power is first applied. The row State 0 has an instruction R:E1 under the Input Pin 1 column. R represents rising edge as the qualifying trigger. This instruction indicates when a rising edge is received by input pin #1 of IC 1202, the Path E1, as indicated by the row 311 of table 300 will be executed. The second and third elements of State 0 are designated by “X”, which mean input pin #2 of processor IC 1202 and received signal of RF receiver IC 1211 are “don't care” or ignored. All the other elements of State 0 are designated by L. It means the output pins 7 and 8 of core processor IC 1202 as well as the connection to the motor drive IC 1213 are set to logic “L”, the low logic level which turns the LEDs and the motor off.

Now the program will proceed only when the flashing light button of the police car is pressed, as controlled by State 0. When Input Pin 1, the flashing light button receives a rising edge, the Path E1, row 311 of table 300 is executed. This path first instructs the microcontroller to turn the active state to State 1, as indicated in row 222 of table 200. At State 1, Output pin #7 of core processor IC 1202 is set to logic high level as shown on state element 231, which turns LED1 on. The input pins 1 and 2 of processor IC 1202 and the RF Receiver IC signal are also set to enable receiving triggers. When Input Pin 1, representing the LED switch receives a rising edge signal, Path E2 will be executed. When Input Pin 2 representing the Siren switch receives a rising edge, Path E4 will be executed. When RF receiver IC 1211 provides a logic high signal to processor IC 1202, E3 will be executed. Assuming no qualified signal is received in State 1, Path E1 continues with the next instruction 313 which cause the microcontroller to issue a delay time of one second, and then it sets State 2 as the active state. When State 2 is set to be active, Output Pin 7 of processor IC 1202 is set to “L” and Output Pin 8 is set to “H”, which turns LED1 off and LED2 on. After delaying for another one second, the last element of Path E1 is “Event E1”, which means the Path E1 is executed again. Accordingly, looping of the Path E1 sets a series of instructions to alternately blink the LEDs 1 and 2 until any of Input Pin 1, 2 or the IC 1211 interface receives a qualifying signal. During State 1 or 2, assuming IC 1211 receives a signal from the remote controller, the RF receiver issues an “H”, or logic high signal to the processor IC 1202. This signal triggers the Path E3, which firstly set the active state to State 3. During State 3, both LED1 and LED2 are turned on. At the same time a logic high, “H” signal is sent by the processor IC 1202 to IC 1213 which turns on the motor of the police car. Path E3 instructs the LEDs and the motor to run for 5 seconds and then returning to Path E1.

If Input Pin 2 receives a rising edge signal during State 1 or State 2, the Path E4 will be executed to generate sounds. The first element of Path E4 is Police Voice #1. When receiving this instruction, processor IC 1202 issues a Police Voice #1 identity to IC 1212 which finds the Police Voice data from it's memory blocks. The processed Police Voice #1 sound is then converted into analog signal for core processor IC 1202 to drive a speaker. The program moves on through the interaction between the instruction settings of the tables 200 and 300.

It can be observed that the used input, output pins of the core processor IC are defined in this Easy Format program. The supporting VSFB ICs 1211 and 1213 are also defined in the program. However, the activities of the sound/voice generating IC 1212 is transparent to the programmer, as the IP Easy Format compiler automatically sets up the communication protocol between the core processor 1202 and the voice IC 1212 when the Police Voice #1 and Siren Sound instructions are received.

The Easy Format program of FIG. 10 demonstrates an example of the IP (integrated programming) disclosed in this invention, which required the core processor IC 1202 to be properly connected with the supporting VSFB ICs and with these connection settings properly declared in the Easy Format program. The compiler automatically recorded the identification addresses of the different voice segments when these voices files are linked with the Easy Format programming. With IP built inside the Easy Format compiler, the COB module 1200 of FIG. 9 is treated as a single microcontroller that receives RF remote control signals and activates the motor drive. Accordingly programmers are not required to program the individual processors 1202, 1211 to 1213 separately. The traditional Assembly Language debug time for the different processor ICs is therefore significantly reduced. With the above examples, it is observed that the complete system of VSFB IC families, IC chip selections, COB hardware integration, software integrated programming method and Easy Format compiler offer tremendous advantages to designers and programmers to quickly providing economical hardware and software designs for electronics products.

Although detailed embodiments of the invention have been disclosed, it is recognized that variations and modifications, such as adding some I/O pins, or providing more functional specific processor ICs are all within the spirit of the invention and will occur to those skilled in the art. It is accordingly intended that all such variations and modifications be encompassed by the appended claims.

I claim:

1. A method to provide a sound generation chip set comprising the steps of:
(1) providing a first processor IC having memory means configured to store audio data representing an audio signal;
(2) providing a second processor IC having input and output pins for interfacing with an external application circuit;
(3) in response to an input signal received, said second processor IC provides a first identification signal to said second processor IC;
(4) in response to said first identification signal received, said first processor IC obtains audio data from said memory means for generating an audio signal;
(5) generating an audio signal according to said audio data; and
(6) converting said audio signal to sound energy by a sound transducer.

2. The method of claim 1 wherein said sound transducer is connected to said second processor IC; said method further comprising a step to feed audio data or audio signal from said first processor to said second processor IC for driving said sound transducer.

3. The method of claim 2 wherein said first and second processor ICs are configured to work together for converting data stored in said memory means into signal suitable for driving said sound transducer.

4. The method of claim 1 wherein said first processor IC is fabricated from a first density IC fabrication process and said second processor is fabricated from a second lower density IC fabrication process.

5. The method of claim 1 wherein said first processor IC is provided by a wafer of diameter m inches and said second processor IC is provided by a wafer of diameter n inches, wherein m is greater than n.

6. The method of claim 1 wherein said first processor IC is configured to operate at a voltage lower than the working voltage of said second processor IC.

7. The method of claim 6 wherein said second processor IC comprising interface circuit configured for communicating with the lower voltage signal requirements of said first processor IC.

8. The method of claim 6 wherein said first processor IC draws lower voltage power from said second processor IC.

9. The method of claim 8 wherein said second processor IC provides a lower regulated voltage for powering said first processor IC.

10. The method of claim 1 wherein said second processor IC is configured to provide PWM signal representing said audio signal for driving directly a sound transducer.

11. The method of claims 1 wherein the designed maximum working clock rate of said first processor IC is higher than the designed maximum working clock rate of said second processor IC.

12. The method of claim 11 wherein said first processor IC is a DSP chip.

13. The method of claim 1 wherein the average current capacity of the output pins of said first processor is lower than the average current capacity of the output pins of said second processor.

14. The method of claim 1 wherein said first processor IC is selected from a family of processor ICs each having different memory capacity for storing audio signals of different durations.

15. The method of claim 1 wherein said second processor IC is selected from a family of processor ICs each having different I/O characteristics.

16. The method of claim 15 wherein said different I/O characteristics is defined by different numbers of I/O pins.

17. The method of claim 16 further comprising a step to provide an IP compiler enabling a programmer to program both first and second processor ICs with a single program.

18. The method of claim 1 further comprising a step to provide an Easy Format® compiler configured to program at least one of said first and second processor ICs.

19. The method of claim 1 wherein said first processor IC is programmable to generate said audio signal and said second processor IC is programmable to control the interactions of said input and output pins with said external application circuit.

20. The method of claim 1 further comprising a step to interface said chip set with an external application circuit for forming an electronics product.

21. A sound generating chip set comprising first and second processor ICs; wherein said first processor IC comprises memory means storing digital data representing an audio signal and said second processor IC is configured to directly drive a sound transducer with an audio signal derived from the digital data stored in said first processor IC.

22. The sound generating chip set of claim 21 wherein the audio signal driving said sound transducer is a pulse width modulation signal.

23. The sound generating chip set of claim 21 wherein said first processor IC is fabricated from a first density IC fabrication process and said second processor is fabricated from a second lower density IC fabrication process.

24. The sound generating chip set of claim 21 wherein said first processor IC operates at a voltage lower than that of said second processor IC, and said second processor IC comprises interface circuit configured for communicating with the lower voltage signal requirements of said first processor IC.

25. The sound generating chip set of claim 21 wherein said first processor IC operates at a voltage lower than that of said second processor IC, and said second processor IC comprises circuit means configured to provide a lower voltage source for powering said first processor IC.

26. The sound generating chip set of claim 21 further comprising an IP compiler enabling a programmer to program said first and second processor ICs with a single program.

27. The sound generating chip set of claim 21 further comprising an Easy Format® compiler configured for programming at least one of said first and second processor ICs.

28. The sound generating chip set of claim 21 wherein said first processor IC is selected from a family of ICs each having different memory size for storing different durations of audio signals.

29. The sound generating chip set of claim 21 wherein said second processor IC is selected from a family of ICs each having different I/O pin characteristics.

30. A sound generating microcontroller represented by an IC chip set comprising a first processor IC and a second processor IC; wherein the majority I/O pins provided to interface with an external application circuit is arranged to be provided by said second processor IC and the memory storing the majority sound data is arranged to be provided by said first processor IC.

31. The sound generating chip set of claim 30 wherein said first and second processor ICs are programmable by an IP compiler.

32. The sound generating chip set of claim 30 wherein at least one of said first and second processor ICs is programmed by an Easy Format® compiler.

33. A method of using an IC chip set to provide a sound generating microcontroller comprising the steps of:
(1) selecting a first processor IC from a first family of ICs each having different memory sizes for storing different sound durations and
(2) selecting a second processor IC from a second family of ICs each having different I/O pins characteristics.
(3) connecting said first and second ICs together with a printed circuit board to form a complete sound generating microcontroller.

34. The method of claim 33 further comprising a step to interface a sound transducer with said second processor IC for producing the sound represented by the data stored in said first processor IC.

35. The method of claim 34 further comprising a step to interface said second processor IC with an external application circuit for forming an electronics product.

36. The method of claim 33 further comprising a step to provide an IP compiler for programming said first and second processor ICs with a single program.

37. The method of claim 33 further comprising a step to provide an Easy Format® compiler for programming at least one of said first and second processor ICs.

38. A microcontroller represented by a COB (chip on board) assembly comprising a first processor IC and a second processor IC; wherein said first processor IC is fabricated with a first density process and said second processor IC is fabricated with a second lower density process for providing the majority input pins and output pins to interface with an external application circuit.

39. The microcontroller of claim 38 wherein said first processor IC comprising memory means configured to provide the majority memory capacity of said microcontroller.

40. The microcontroller of claim 39 wherein said memory means of said first processor IC stores digital data representing audio signals.

41. The microcontroller of claim 38 wherein said first and second processor ICs are programmed by an IP compiler.

42. The microcontroller of claim 38 wherein at least one of said first and second processor ICs is programmed by an Easy Format® compiler.

43. A microcontroller chip set comprising a first processor IC and a second processor IC; wherein
said first processor IC is fabricated with a first operating voltage process and said second processor IC is fabricated with a second higher operating voltage process; and
said second processor IC is configured to provide a step down voltage for powering said first processor IC.

44. The microcontroller chip set of claim 43 wherein said second processor IC comprises circuit means providing regulated lower voltage to power said first processor IC.

45. The microcontroller chip set of claim 43 wherein said second processor IC comprises programmable circuit for instructing said first processor IC to enter into low current standby mode.

46. The microcontroller of claim 43 wherein said first and second processor ICs are programmed by an IP compiler.

47. The microcontroller of claim 43 wherein at least one of said first and second processor ICs is programmed by an Easy Format® compiler.

48. A microcontroller comprising:
first and second ALUs;
first group of m input and output pins;
second group of n input and output pins wherein n is substantially larger than m;
first memory block of size p bytes;
second memory block of size q bytes wherein p is substantially larger than q;
said microcontroller is further characterized in that said first ALU, said first group of input and output pins and said first memory block are fabricated with a first high density fabrication process to provide a first processor IC;
said second ALU, said second group of input and output pins and said second memory are fabricated with a second lower density fabrication process to provide a second processor IC and
at least two input/output pins of said first processor IC are connected with said second processor IC for receiving instructions from said second processor IC and for sending data to said second processor IC.

49. The microcontroller of claim 48 wherein said first processor IC is selected from a first family of processor ICs each having different memory sizes for storing data representing audio or graphic information and said second processor IC is selected from a second family of processor ICs each having different I/O pins characteristics.

50. The microcontroller of claim 49 wherein said microcontroller is controlled by a single program controlling the activities of said first and second processor ICs.

51. The microcontroller of claim 50 wherein said program specified the members selected from said first and second families of processor ICs.

52. The microcontroller of claim 48 wherein said first processor IC is powered by said second processor IC.

53. The microcontroller of claim 48 wherein at least one of said first and second processor ICs is programmed by an Easy Format® compiler.

54. A first processor IC configured for generating semi-processed information data comprising
memory means storing at least a first group and a second group of stored data;
at least one input pin configured for receiving identification information about said stored data from an external second processor IC;
circuit means configured for processing said stored data to produce said semi-processed information data in response to said identification information received; and
at least one output pin configured for sending said semi-processed information data to said external second processor IC.

55. The first processor IC of claim 54 wherein said external second processor IC is configured to convert said semi-processed information data into fully processed information data for interfacing with an external transducer.

56. The first processor IC of claim 54 wherein said stored data represents audio or visual information.

57. The first processor IC of claim 54 wherein said first processor IC is provided by a higher density fabrication process than that of said external second processor IC.

58. The first processor IC of claim 54 wherein said first processor IC is configured to operate at a voltage lower than that of said external second processor IC.

59. The first processor IC of claim 58 wherein said first processor IC is configured to receive power from said external second processor IC.

60. The first processor of claim 54 wherein said first and external second processor ICs are programmed by an IP compiler.

61. The first processor of claim 54 wherein at least one of said first and second processor ICs is programmed by an Easy Format® compiler.

62. A power management processor IC configured to work at a first operating voltage and to power one or more external processors IC working at a second lower voltage, said power management processor IC comprises:
first group of I/O pins configured for interfacing with an external application circuit;
at least one pin to offer said second lower voltage for powering a second external processor IC;
at least one input and/or output pin configured to work at said second lower voltage for interfacing with said external second processor IC; and
memory means storing program controlling the interaction of said first group of I/O pins with said external application circuit;

63. The power management processor IC of claim 62 further comprising output pin for interfacing a sound transducer.

64. The power management processor IC of claim 62 further combining with said second processor IC to form a microcontroller chip set; wherein the majority I/O pins interfacing with said external application are provided by said power management processor IC.

65. The power management processor IC of claim 62 further configured to provide regulated voltage to said second external processor IC.

66. The power management processor IC of claim 62 wherein said power management processor IC controls the standby or sleep mode of said second external processor IC.

67. The power management processor IC of claim 62 further configured to provide selectable voltages for powering said second external processor IC.

68. A power management processor IC configured to work at a first operating voltage and to interface with at least one external processor IC working at a lower second voltage, said power management processor IC is structured with at least one pin to offer said second lower voltage for powering a second external processor IC; wherein said power management processor IC is further configured with at least one of the following structures:
(1) a PWM driving circuit suitable for driving a audio transducer directly;
(2) a pair of input and output pins wherein said input pin is configured to receive input signal of level proximate to said lower second voltage and said output pin is configured to provide signal corresponds to said input signal with interfacing characteristic transformed;
(3) a first and second groups of input and/or output pins, said second groups of input and/or output pins are configured for interfacing said external processor IC; wherein said power management processor IC provides an identity signal to said external processor IC in response to a trigger signal received from said first group of input and/or output pins.
(4) a circuit for said power management processor IC to select the second lower voltage for powering said external processor IC.

69. The power management processor of claim 68 wherein said power management processor IC is selected from a family of processor ICs each having different I/O characteristics.

70. The power management processor of claim 68 further configured to interface with a selected member of a family of external processor ICs, each having different memory capacity.
